(19) United States
(12) Patent Application Publication
(10) Pub. No.: US 2014/0023001 A1
(43) Pub. Date: Jan. 23, 2014

(54) APPARATUSES AND METHODS OF DETECTION OF INTERFERING CELL COMMUNICATION PROTOCOL USAGE

(71) Applicant: Qualcomm Incorporated, San Diego, CA (US)

(72) Inventors: Yi HUANG, San Diego, CA (US); Tao Luo, San Diego, CA (US); Wanshi Chen, San Diego, CA (US); Taesang Yoo, San Diego, CA (US); Siddhartha Mallik, San Diego, CA (US); Makesh Pravin John Wilson, San Diego, CA (US)

(21) Appl. No.: 13/939,140

(22) Filed: Jul. 10, 2013

Related U.S. Application Data
(60) Provisional application No. 61/674,222, filed on Jul. 20, 2012.

(51) Int. Cl. H04W 24/02

(52) U.S. Cl. CPC H04W 24/02
USPC 370/329

(57) ABSTRACT

A method, an apparatus, and a computer program product for wireless communication are provided in connection with UE centric interfering cell communication protocol usage detection. In one example, a communications device (e.g., a UE) is equipped to receive one or more signals from each cell of a plurality of cells including a set of interfering cells. The set of interfering cells includes one or more interfering cells. The UE can detect system release version information for at least one cell from the set of interfering cells, and then modify its communication processing with a serving cell based on the detected system release version information.

### CLAIM OF PRIORITY UNDER 35 U.S.C. §119

The present Application for Patent claims priority to Provisional Application No. 61/674,222 entitled “APPARATUSES AND METHODS OF DETECTION OF INTERFERENCE CELL COMMUNICATION PROTOCOL USAGE” filed Jul. 20, 2012, and assigned to the assignee hereof and hereby expressly incorporated by reference herein

### BACKGROUND

1. Field

The present disclosure relates generally to communication systems, and more particularly, to a systems and methods for user equipment (UE) centric detection of interfering cell communication protocol usage.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with UE centric interfering cell communication protocol usage detection. In one example, a communications device (e.g., a UE) is equipped to receive one or more signals from each cell of a plurality of cells including a set of interfering cells. The set of interfering cells includes one or more interfering cells. The UE can detect system release version information for at least one cell from the set of interfering cells, and then modify its communication processing with a serving cell based on the detected system release version information.

According to related aspects, a method for UE centric interfering cell communication protocol usage detection is provided. The method can include receiving, by a UE, one or more signals from each cell of a plurality of cells including a set of interfering cells. The set of interfering cells includes one or more interfering cells. Further, the method can include detecting system release version information for at least one cell from the set of interfering cells. Moreover, the method may include modifying communication processing with a serving cell based on the detected system release version information.

Another aspect relates to a communications apparatus enabled to detect interfering cell communication protocol usage. The communications apparatus can include means for receiving, by a UE, one or more signals from each cell of a plurality of cells including a set of interfering cells. The set of interfering cells includes one or more interfering cells. Further, the communications apparatus can include means for detecting system release version information for at least one cell from the set of interfering cells. Moreover, the communications apparatus can include means for modifying communication processing with a serving cell based on the detected system release version information.

Another aspect relates to a communications apparatus. The apparatus can include a processing system configured to receive one or more signals from each cell of a plurality of cells including a set of interfering cells. The set of interfering cells includes one or more interfering cells. Further, the processing system may be configured to detect system release version information for at least one cell from the set of interfering cells. Moreover, the processing system may further be configured to modify communication processing with a serving cell based on the detected system release version information.

Still another aspect relates to a computer program product, which can have a computer-readable medium including code for receiving, by a UE, one or more signals from each cell of a plurality of cells including a set of interfering cells. The set of interfering cells includes one or more interfering cells. Further, the computer-readable medium may include code for detecting system release version information for at least one cell from the set of interfering cells. Moreover, the computer-readable medium can include code for modifying communication processing with a serving cell based on the detected system release version information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating an example of an access network with interfering cells.

FIG. 8 is a flow chart of a method of wireless communication.

FIG. 9 is another flow chart of a method of wireless communication.

FIG. 10 is a conceptual data flow diagram illustrating the data flow between different modules/means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

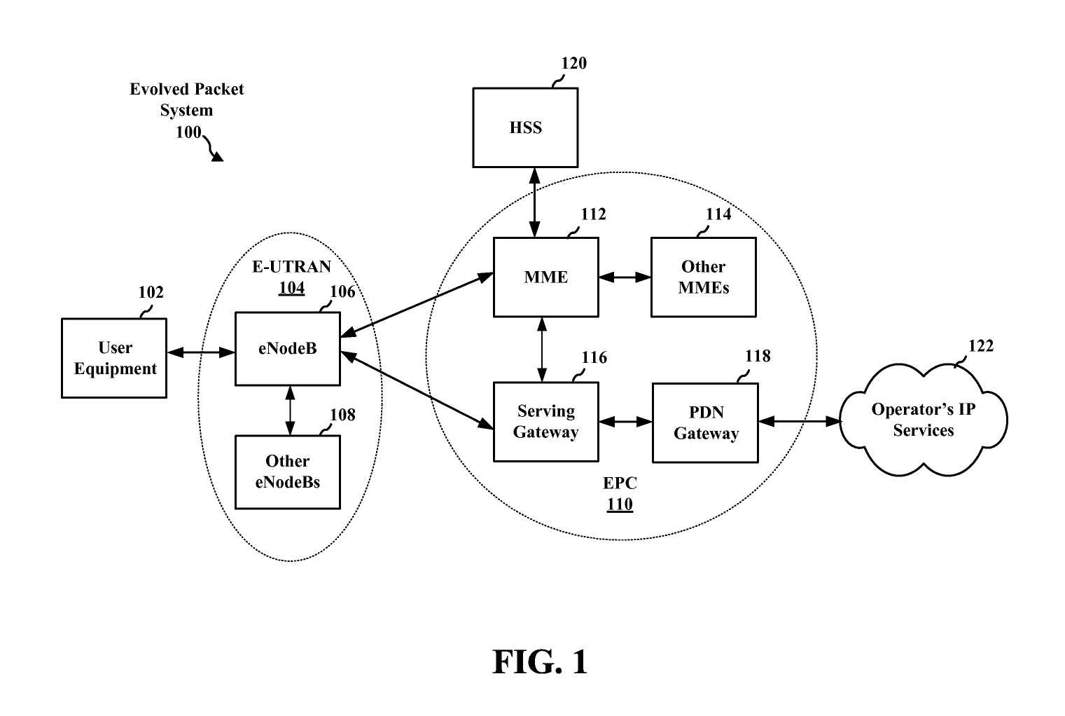

FIG. 1 is a diagram illustrating an LTE network architecture. The LTE network architecture may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

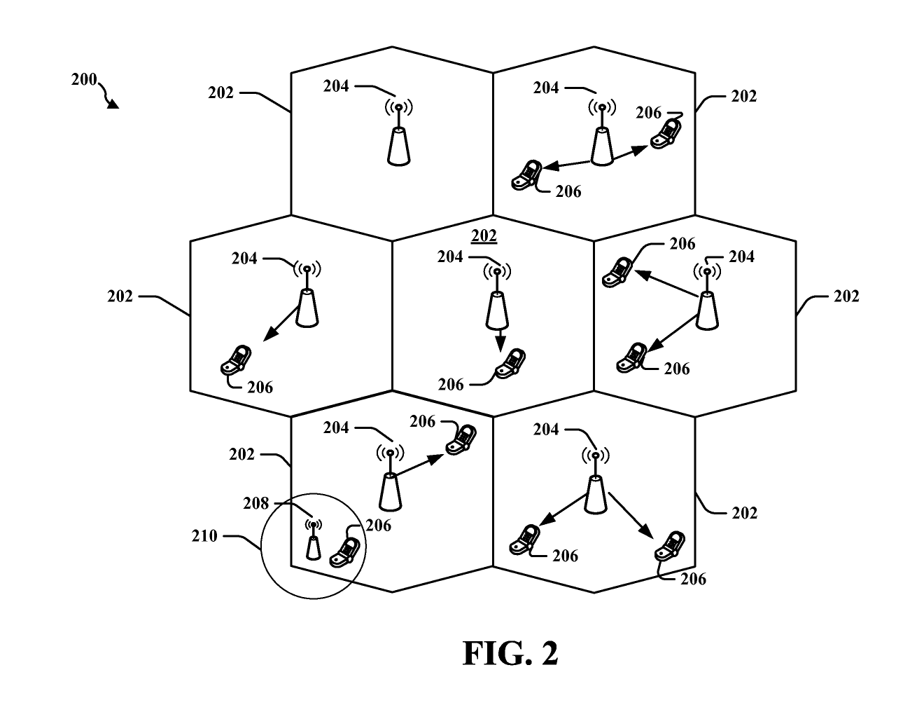

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of amplitude and phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

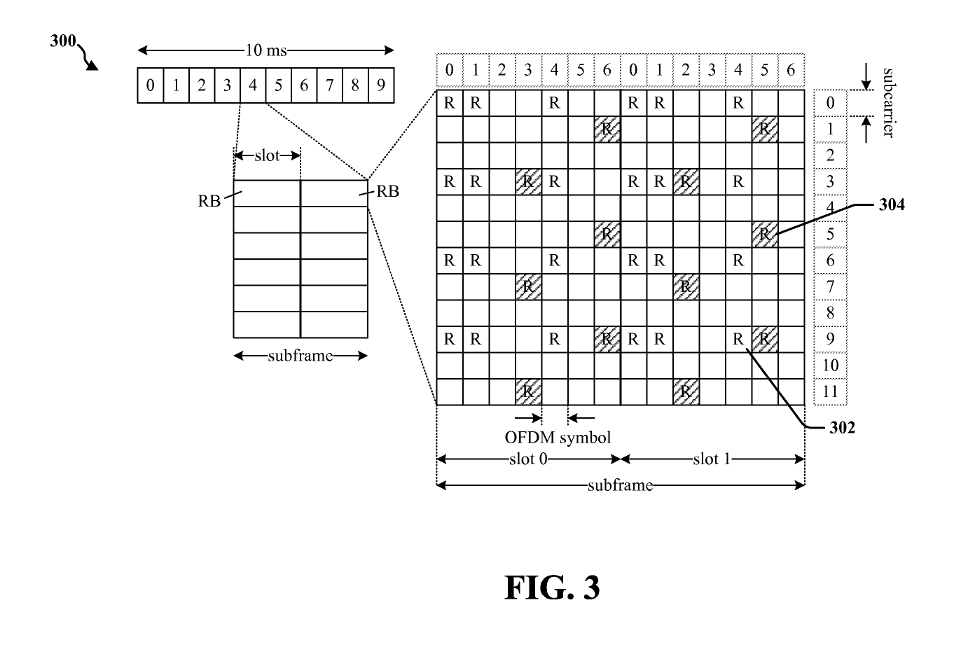

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain, resulting in a total of 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

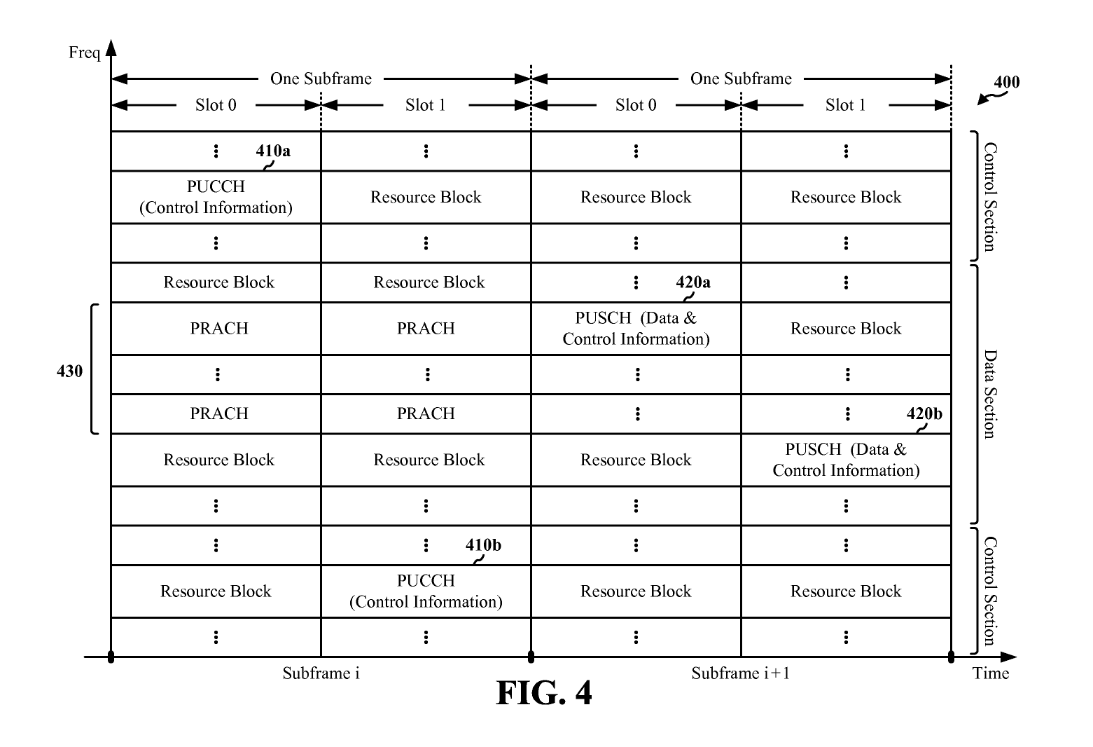

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

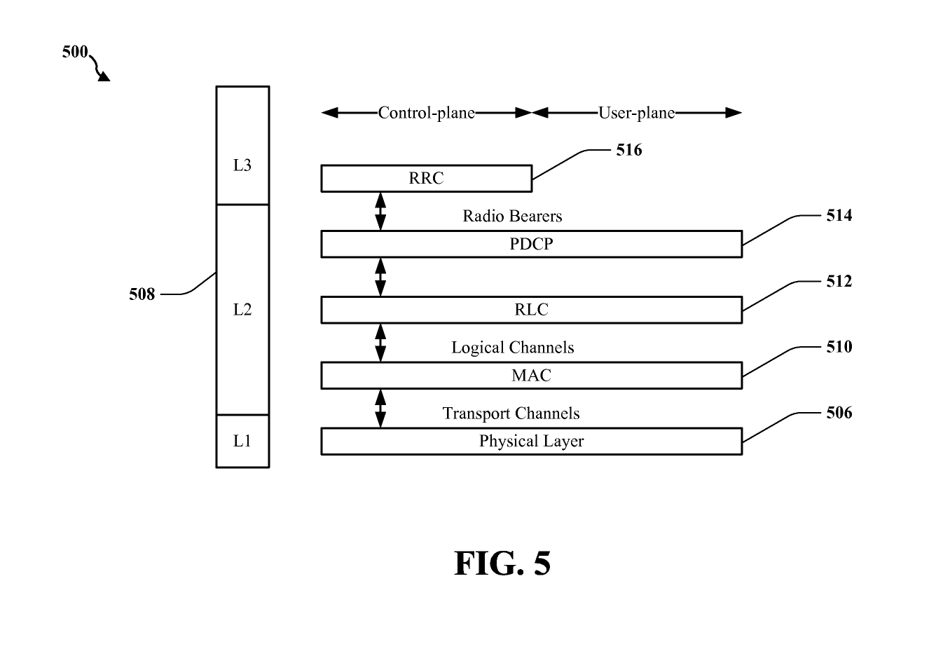

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

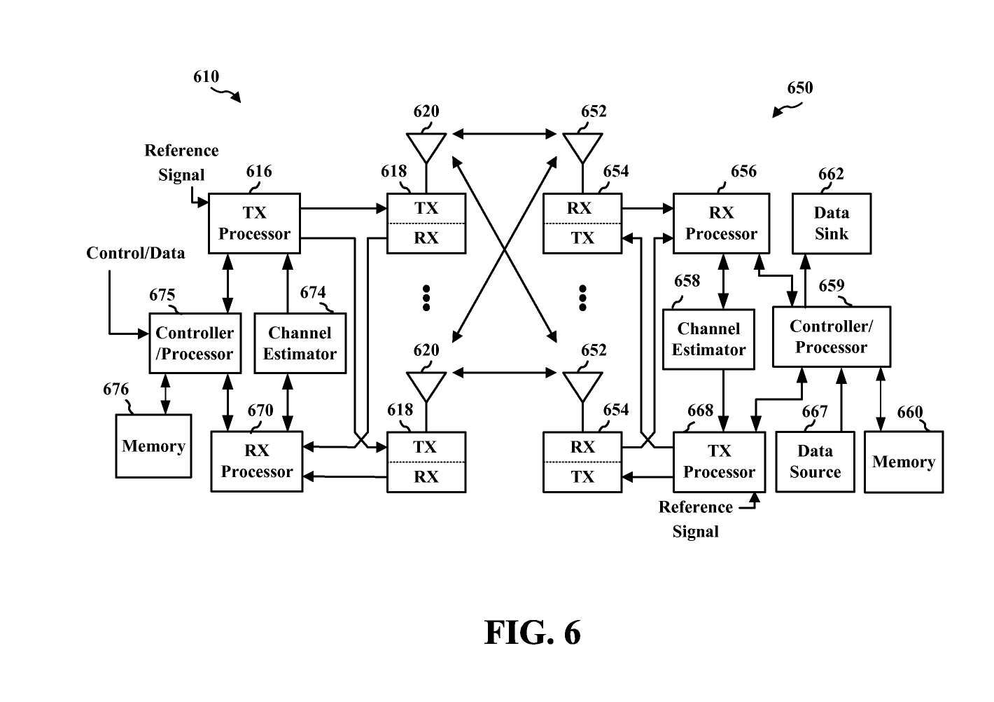

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

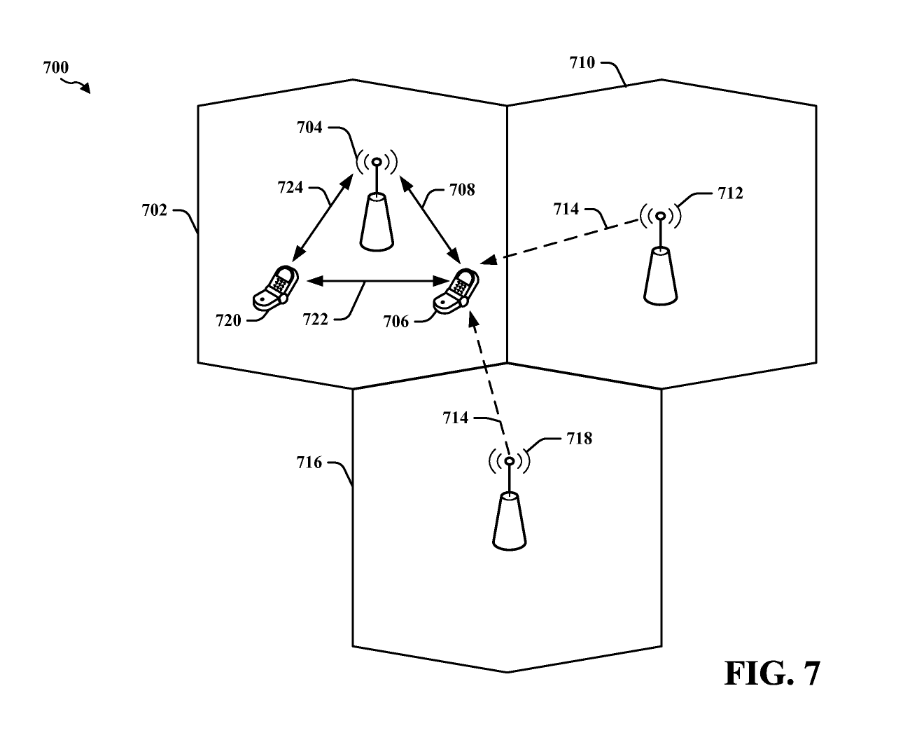

FIG. 7 is a diagram 700 illustrating an example of an access network 700 in which one or more interfering cells 710, 716 may provide interference 714 to a UE 706, which is in communication 708 with an eNB 704 and associated with a serving cell 702. In an aspect, the interference 714 detected from the interfering cells 710, 716 may be generated by eNBs 712, 718. Additionally, access network 700 may include one or more other UEs 720 that may be in communication 722 with UE 706 and/or in communication 724 with eNB 704.

In an operational aspect, UE 706 may be configured to process and analyze signals (708, 714) received from multiple eNBs, including the serving eNB 704 and one or more interfering eNBs 712, 718. In an aspect, signals (708, 714) may include information that can assist UE 706 in determining system release version information for any and/or all of the eNBs (704, 712, 718). In one aspect, UE 706 may detect system release information based on system information block (SIB) structure. For example, in SIB1/2, there may be release specific information (e.g., additional signaling structure that has been defined for later release versions (e.g., LTE Rel. 10 and newer)). In another aspect, UE 706 may detect various release specific features and determine the system release version based on detected features. For example, such features may include, but are not limited to channel state information reference signal (CSI-RS) , carrier type, evolved physical downlink control channel (ePDCCH), transmission mode (TM), almost blank subframe (ABS) configuration, aperiodic Sounding Reference Signal (SRS), carrier aggregation, etc.

With respect to CRI-RS, UE 706 may attempt to detect the presence of CSI-RS. If the UE 706 detects CSI-RS in any of the signals (708, 714), then the eNB transmitting the signaling is using LTE Rel. 10 or newer. Once UE 706 determines CRI-RS is present, the UE 706 may use blind transmission type detection (BTTD) for energy detection. In such an aspect, by assuming a Rel-10 based sequence mapping, the UE 706 may derive whether the signal corresponds to Rel-10 or Rel-11. For example, with Rel-11 a virtual physical cell identifier (PCI) may be in use where there is a strong CSI-RS tone at a location and where energy is not detected.

With respect to carrier type detection, UE 706 may detect whether a cell (710, 716) is a using newer or legacy carrier. In such an aspect, the UE may detect whether PCFICH is present and/or may detect a number of subframes where CRS is present within a duration of subframes (e.g., 5 subframes). Accordingly, based on the presence or absence of PCFICH and/or the number of CRSs in the subframe duration, the UE may determine whether the cell is using a newer carrier or a legacy carrier.

With respect to ePDCCH detection, UE 706 may determine that non-uniform transmission within one PRB may indicate the presence of an ePDCCH transmission. In another aspect, UE 706 may detect ePDCCH based on coding scheme, where ePDCCH uses a convolutional coding, while PDSCH uses a turbo coding.

In another optional aspect, UE 706 may use filtering (e.g., long-term filtering) to detect system release version information. In such an aspect, UE 706 may detect the system release version information over a period of time and/or multiple RBs. UE 706 may estimate and filter the probability of UE-RS usage from one cell and use the information to bias a BTTD algorithm. Further, UE 706 may estimate and filter the probability of transmission mode (TM) usage and use the information to bias a blind spatial scheme detector (BSSD) and/or a Rank 1 detector. Still further, UE 706 may estimate and filter the probability of type 2 distributed resource allocation and use the information for traffic to pilot ratio (TPR) algorithm, BTTD, BSSD, etc., or any combination thereof. In another aspect, filtering information may be used to identify the presence of RB bundling. For example, where a UE is configured to use TM 9 with precoding matrix indicator/rank indicator (PMI/RI) feedback, it may be assumed that the precoding is configured across multiple RBs in the frequency domain. As such, a long-term filtering technique can be used to decide the presence of and information associated with RB bundling. This determined bundling information may be used to help with BTTD (e.g., UE-RS detection).

In another optional aspect, multiple UEs (706, 720) may cooperate to determine system release information feature for one or more interfering eNBs (712, 718). In an aspect, each UE (706, 720) may independently determine the system release version information for one or more eNB (712, 718). This information may be sent to a ‘fusion center’ which aggregates the information. This fusion center could reside in the eNodeB, a UE, etc. The fusion center may aggregate these individual determinations from various sources to generate an improved determination. The fusion center may then broadcast this information (e.g., to one or more cells) via a SIB, which UEs then use to access the information. In another aspect, each UE (706, 720) may independently decide system release version information for one or more eNB (712, 718). The UE (706, 720) may communicate 722 (e.g., broadcast) this information to neighboring UEs (706, 720). Thereafter, neighboring UEs (706, 720) locally combine received information and broadcasts combined information. Accordingly, an iterative consensus results may be reached after one or more hearing-combining-broadcast iterations.

In another aspect, UE 706 may detect uplink and/or downlink subframe information for one or more of the interfering eNBs (712, 718). The UE 706 may use this information to assist in determining how/whether to cancel interference due to UL transmissions, DL receptions, etc., or any combination thereof.

In still another optional aspect, the UE 706 may use information associated with an eNB (e.g., 704) to infer system release information for one or more other related eNBs (e.g., (712, 718). For example, where the UE 706 determines an eNB 704 is using Rel-10, then the UE 706 may infer than any cooperating eNBs are also using Rel-10 or newer versions of LTE.

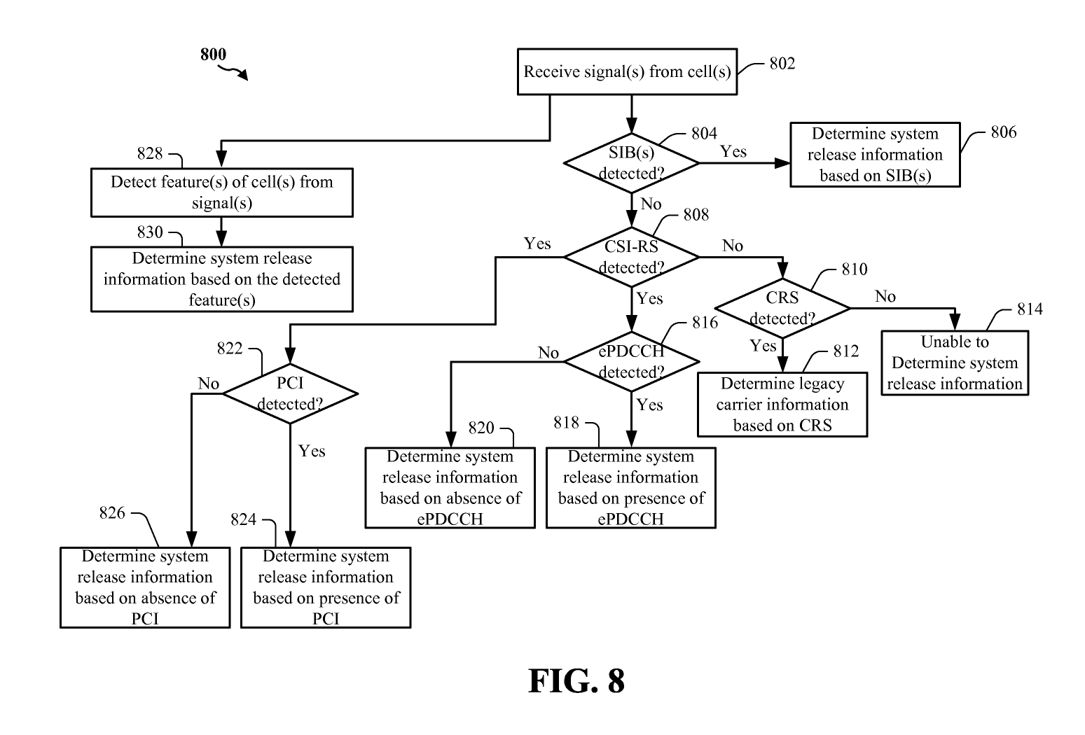

FIGS. 8, 9, and 12 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could be performed as a series of interrelated states or events, and/or substantially in parallel. Further, the various methodologies described in the blocks below may be performed individually or in any combination.

FIG. 8 is a flow chart 800 of a method of wireless communication. The method may be performed by a UE.

At block 802, the UE may receive one or more signals from a plurality of cells.

At block 804, the UE may determine whether the received signal includes SIB information. If at block 804, the UE determines that SIB information has been received, then at block 806, the UE may use the SIB information to determine the system release version information. For example, in SIB1/2, there may be release specific information (e.g., additional signaling structure that has been defined for later release versions (e.g., LTE Rel. 10 and newer).

By contrast and/or in addition to the decision at block 804, at block 808, the UE may determine whether CSI-RS has been detected. If at block 808, no CSI-RS is detected or in addition to the decision at block 808, at block 810, the UE determines whether a CRS is detected. If at block 810, CRS is detected, then at block 812, the UE may determine that the system release information corresponds to a legacy carrier information based on the CRS information. In such an aspect, the UE may detect whether PCFICH is present and/or may detect a number of subframes where CRS is present within a duration of subframes (e.g., 5 subframes). Accordingly, based on the presence or absence of PCFICH and/or the number of CRSs in the subframe duration, the UE may determine whether the cell is using a newer carrier or a legacy carrier.

By contrast, if at block 810, the UE does not detect a CRS, then a block 814, the UE may determine that it is unable to determine system release version information from the received signals.

Returning to block 808, in response to detecting a CSI-RS at block 808 and/or in addition to the determination, at block 816, the UE may determine if ePDCCH is detected. In an aspect, the UE may determine that non-uniform transmission within one PRB may indicate ePDCCH transmission. In another aspect, the UE may detect EPDCCH based on coding scheme, where ePDCCH uses convolutional coding, while PDSCH uses turbo coding.

Thereafter, the UE may determine system release information based on the presence (block 818) or absence (block 820) of ePDCCH.

In another aspect, returning to block 808, in response to detecting a CSI-RS at block 808, the UE may perform energy detection upon detection of the CSI-RS.

At block 822, the UE may determine whether energy detection results in a determination that a PCI value is virtual or physical. Thereafter, the UE may determine system release information based on the presence (block 824) or absence (block 826) of a PCI corresponding to a physical PCI. In such an aspect, by assuming a Rel-10 sequence mapping, the UE may determine whether the signal is Rel-10 or Rel-11 based. For example, with Rel-11 a virtual physical cell identifier (PCI) may be in use where there is a strong CSI-RS tone at a location and where energy is not detected.

Additionally or in the alternative, at block 828, the UE may detect various features associated with the signals received at block 802. For example, the UE may detect a transmission mode for at least one cell from the set of interfering cells. In another aspect, the UE may detect almost blank subframe (ABS) configuration for at least one cell from the set of interfering cells. In another aspect, the UE may detect carrier type information for at least one cell from the set of interfering cells. In another aspect, the UE may detect carrier aggregation information for at least one cell from the set of interfering cells. In another aspect, the UE may detect aperiodic Sounding Reference Signal (SRS) information for at least one cell from the set of interfering cells.

At block 830, the UE may determine system release information based on any of the detected features, alone or in combination.

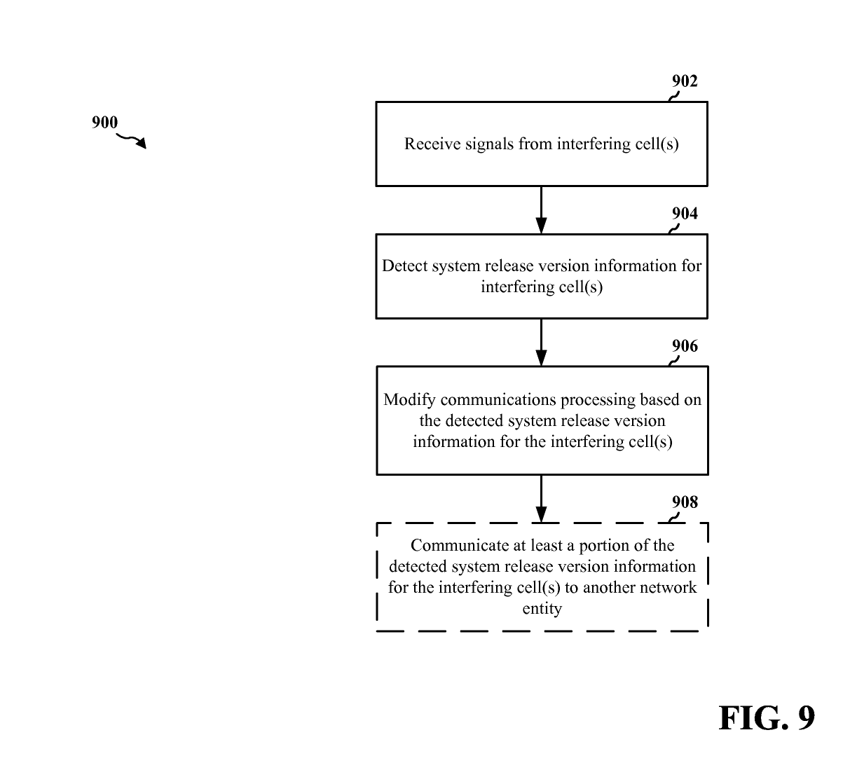

FIG. 9 is a flow chart 900 of a method of wireless communication. The method may be performed by a UE. In FIG. 9, dashed boxes correspond to optional steps that may be included in alternative aspects of the wireless communication method.

At block 902, the UE may receive receives one or more signals from a plurality of cells. In an aspect, the UE may receive signals from an interfering cell. Additionally, or in the alternative, the UE may further receive one or more signals from a serving cell. In such an aspect, the serving cell may provide information in the signals, such as but not limited to, system release version information for the serving cell, system release version information for interfering cell, information associated with features of the signals from various cells, etc. In still another aspect, the UE may receive system release version information from multiple network entities (e.g., other UEs, NodeB, eNodeB, etc.).

At block 904, the UE may detect system release version information for one or more cells based on the received signals. In one aspect, the UE may detect the system release version information for one or more cells based on release specific signaling structures on a SIB in the received signal. For example, additional signaling structure has been defined for later release version of LTE. In another aspect, the UE may detect the system release version information for one or more cells based on the presence or absence of features within the signals. In such an aspect, such features may include, but are not limited to, CSI-RS, carrier type, ePDCCH, transmission mode, ABS configuration, aperiodic SRS, carrier aggregation, etc., or a combination thereof. In another aspect, the UE may detect the system release version information for one or more cells based on express signaling of system release version information (e.g., in a SIB). As noted above, the express signaling may include information in the signals (e.g., SIB1/2), such as but not limited to, system release version information for the serving cell, system release version information for interfering cell, information associated with features of the signals 1054 from various cells, etc., or a combination thereof. In another aspect, the UE may detect the system release version information for one or more cells using filtering. For example, filtering (e.g., long term filtering) may be used to estimate the probability of UE-RS usage from one cell, to estimate the probability of TM modes, to estimate and the probability of type 2 distributed resource allocation, to determine RB bundling configurations, etc.

In an optional aspect, at block 906, the UE may modify communication processing based on the detected system release version information. In an aspect, the UE may modify physical downlink channel processing based on the detected system release version information. In another aspect, the UE may modify its own interference cancelation (IC) techniques, processes, or mechanisms or request that the serving node adjust its transmission in light of the detected release versions of the interfering eNBs and/or UEs. For example, the UE may employ CRS-IC, primary synchronization signal (PSS)-IC, physical broadcast channel (PBCH)-IC, Physical Hybrid-ARQ Indicator Channel (PHICH)-IC, Physical Downlink Control Channel (PDCCH)-IC, Physical Downlink Shared Channel (PDSCH)-IC, etc.

In an optional aspect, at block 908, the UE may communicate the detected system release version information to at least one other network entity. In an aspect, the network entity may be one or more other UEs, an eNB, etc. In another aspect, the transmitted system release version information may be used by the network entity along with system release version information provided by other UEs to improve one or more of its system communication schemes. In an aspect in which the UE receives system release version information from multiple UEs, the UE may determine improved release version information based on the received system release version information. In an aspect, the network entity may aggregate the various received system release version information to compute one or more schemes in which the influence on communications from interfering cells is reduced.

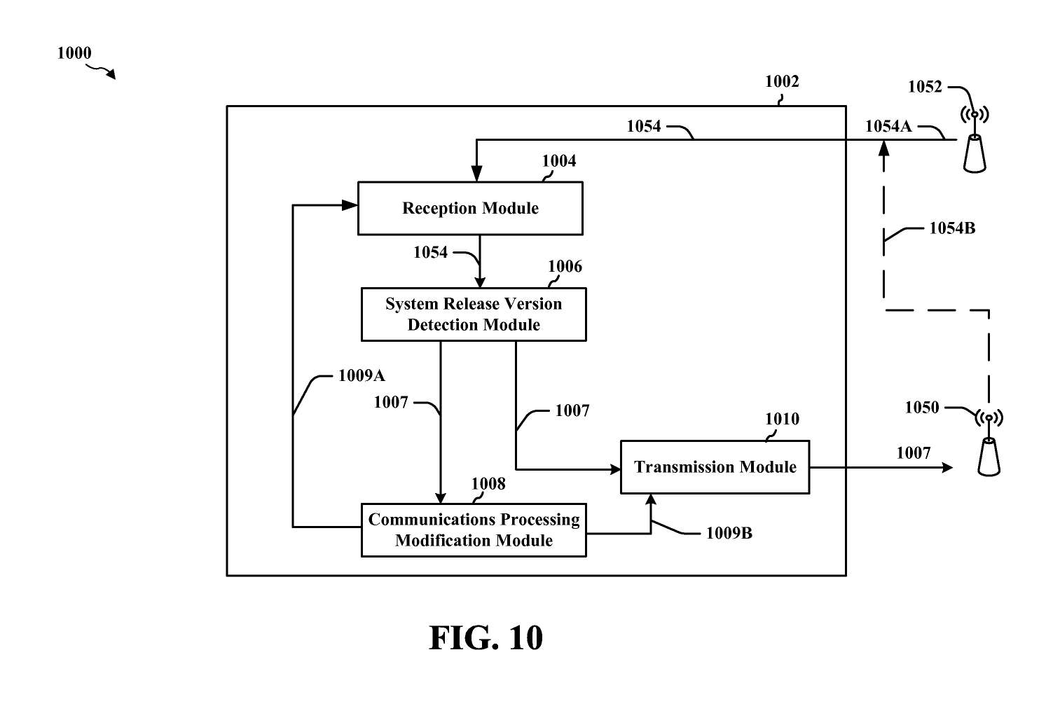

FIG. 10 is a conceptual data flow diagram 1000 illustrating the data flow between different modules/means/components in an exemplary apparatus 1002. The apparatus may be a UE. The apparatus includes a reception module 1004 that receives one or more signals (1054) from a plurality of cells (e.g., 1050, 1052). In an aspect, reception module 1004 may receive signals 1054A from an interfering cell 1052. Additionally, or in the alternative, reception module 1004 may further receive one or more signals 1054B from a serving cell 1050. In such an aspect, the serving cell 1050 may provide information in the signals 1054, such as but not limited to, system release version information for the serving cell 1050, system release version information for interfering cell 1052, information associated with features of the signals 1054 from various cells (1050, 1052), etc.

Further, the apparatus includes a system release version detection module 1006 that can detect system release version information 1007 for one or more cells (1050, 1052) based on the received signals 1054. In one aspect, system release version detection module 1006 may detect the system release version information for one or more cells (1050, 1052) based on release specific signaling structures on a SIB in the received signal 1054. For example, additional signaling structure has been defined for later release version of LTE. In another aspect, system release version detection module 1006 may detect the system release version information for one or more cells (1050, 1052) based on the presence or absence of features within the signals 1054. Such features may include, but are not limited to, CSI-RS, carrier type, ePDCCH, transmission mode, ABS configuration, aperiodic SRS, carrier aggregation, etc. or a combination thereof. In another aspect, system release version detection module 1006 may detect the system release version information for one or more cells (1050, 1052) based on express signaling of system release version information. The express signaling may be received from a network entity, such as a UE or eNB. Further, as noted above, the express signaling may include information signaling 1054, such as but not limited to, system release version information for the serving cell 1050, system release version information for interfering cell 1052, information associated with features of the signals 1054 from various cells (1050, 1052), etc, or any combination thereof. In another aspect, system release version detection module 1006 may detect the system release version information for one or more cells (1050, 1052) using filtering. For example, filtering (e.g., long term filtering) may be used to estimate the probability of UE-RS usage from one cell, to estimate the probability of TM modes, to estimate and the probability of type 2 distributed resource allocation, to determine RB bundling configurations, etc., or a combination thereof.

Additionally, the apparatus may include a communications processing modification module 1008 that can modify communication processing based on the detected system release version information. In an aspect, communications processing modification module 1008 may provide modification suggestions/instructions (1009A, 1009B) to reception module 1004 and/or transmission module 1010 to improve communications. In an aspect, communications processing modification module 1008 may modify physical downlink channel processing based on the detected system release version information. In another aspect, communications processing modification module 1008 may modify interference cancelation (IC). For example, CRS-IC, primary synchronization signal (PSS)-IC, physical broadcast channel (PBCH)-IC, Physical Hybrid-ARQ Indicator Channel (PHICH)-IC, Physical Downlink Control Channel (PDCCH)-IC, Physical Downlink Shared Channel (PDSCH)-IC, etc.

Moreover, the apparatus may include a transmission module 1010 that can communicate the detected system release version information 1007 to at least one network entity (e.g., 1050). In an aspect, the network entity may be one or more other UEs, an eNB (e.g., 1050), etc. In another aspect, the transmitted system release version information 1007 may be used by the network entity along with system release version information provided by other UEs to determine improved system communications schemes.

The apparatus may include additional modules that perform each of the steps of the algorithm in the aforementioned flow charts of FIGS. 8 and 9. As such, each step in the aforementioned flow charts of FIGS. 8 and 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

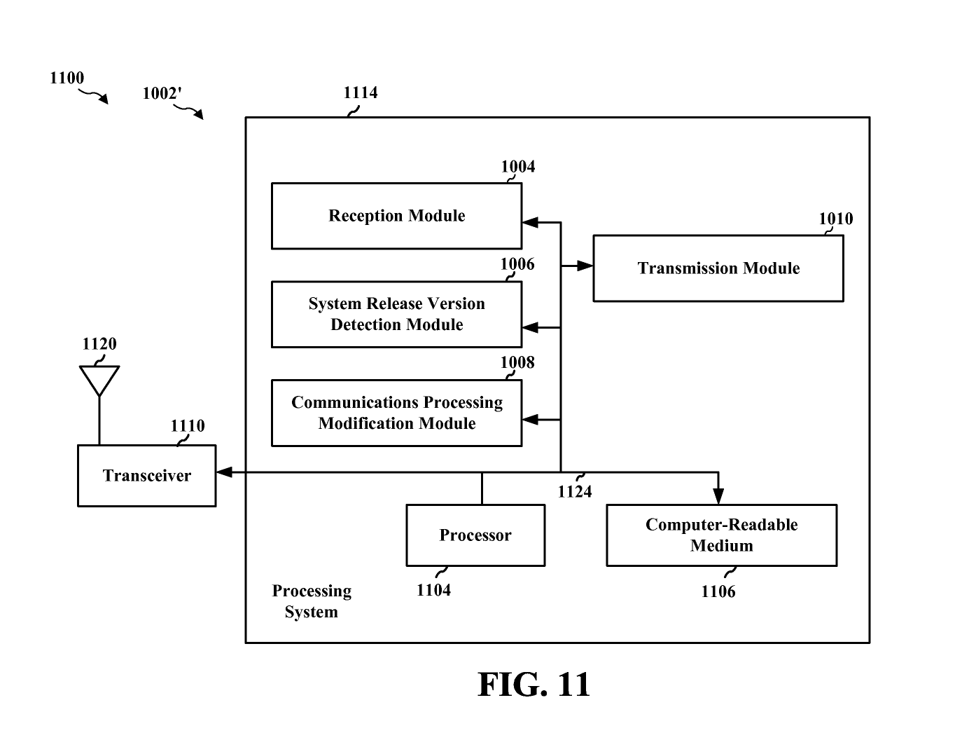

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1104, the modules 1004, 1006, 1008, 1010 and the computer-readable medium 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The processing system 1114 includes a processor 1104 coupled to a computer-readable medium 1106. The processor 1104 is responsible for general processing, including the execution of software stored on the computer-readable medium 1106. The software, when executed by the processor 1104, causes the processing system 1114 to perform the various functions described supra for any particular apparatus. The computer-readable medium 1106 may also be used for storing data that is manipulated by the processor 1104 when executing software. The processing system further includes at least one of the modules 1004, 1006, 1008, and 1010. The modules may be software modules running in the processor 1104, resident/stored in the computer-readable medium 1106, one or more hardware modules coupled to the processor 1104, or some combination thereof. The processing system 1114 may be a component of the UE 650 and may include the memory 660 and/or at least one of the TX processor 668, the RX processor 656, and the controller/processor 659.

In one configuration, the apparatus 1002/1002′ for wireless communication includes means for receiving one or more signals from each cell of a plurality of cells including a set of interfering cells, the set of interfering cells including one or more interfering cells, means for detecting system release version information for at least one cell from the set of interfering cells, and means for modifying communication processing based on the detected system release version information. The apparatus 1002/1002′ may further include means for communicating the detected system release version information to at least one network entity. In a configuration, the apparatus 1002/1002′ means for receiving may be further configured to receive, from two or more UEs, system release version information. In such a configuration, the means for modifying may be further configured to determine improved release version information based on the received system release version information. In such an aspect, the apparatus 1002/1002′ means for communicating may be configured to communicate the improved release version information. In an aspect, the means for communicating may be configured to broadcast the improved release version information, transmit the improved release version information to the two or more UEs, etc. The aforementioned means may be one or more of the aforementioned modules of the apparatus 1002 and/or the processing system 1114 of the apparatus 1002′ configured to perform the functions recited by the aforementioned means. As described supra, the processing system 1114 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
receiving, by a user equipment (UE), one or more signals from each cell of a plurality of cells including a set of interfering cells, the set of interfering cells including one or more interfering cells;
detecting system release version information for at least one cell from the set of interfering cells; and
modifying communication processing with a serving cell based on the detected system release version information for the at least one cell from the set of interfering cells.

2. The method of claim 1, wherein at least one of one of the one or more signals includes a system information block (SIB) configured with a first structure, and wherein the detecting further comprises detecting the system release version information based on the first structure of the SIB.

3. The method of claim 1, wherein one cell of the plurality of cells is a serving cell, and wherein the one or more received signals include at least one of:
system release version information for the serving cell;
system release version information for at least one cell from the set of interfering cells; or
information associated with features, from which the system release version information can be inferred, for at least one of interfering cell.

4. The method of claim 1, wherein at least one signal, from the one or more signals, includes a channel state information reference signal (CSI-RS) tone, and wherein the detecting further comprises identifying the system release version is a long term evolution (LTE) release 10 or newer version.

5. The method of claim 4, wherein the detecting further comprises detecting that an energy level associated with the CSI-RS tone is below a physical cell identifier (PCI) energy threshold value, and determining that the system release version is a LTE release 11 or newer version.

6. The method of claim 1, wherein the detecting further comprises:
determining that at least one signal of the one or more received signals includes an evolved physical downlink control channel (ePDCCH); and
determining that the system release version is a LTE release 11 or newer version based on the presence of the ePDCCH.

7. The method of claim 1, wherein the detecting further comprises:
determining that none the one or more received signals include an Physical Control Format Indicator Channel (PCFICH); and
determining that the system release version corresponds to a legacy carrier.

8. The method of claim 1, wherein the detecting further comprises:
detecting a number of common reference signals (CRS) are present during a duration of time; and
determining that the system release version corresponds to a legacy carrier based on the detected number of CRS during the duration of time.

9. The method of claim 1, wherein the detecting further comprises detecting at least one of:
a transmission mode for at least one cell from the set of interfering cells;
almost blank subframe (ABS) configuration for at least one cell from the set of interfering cells;
carrier type information for at least one cell from the set of interfering cells;
carrier aggregation information for at least one cell from the set of interfering cells; or
aperiodic Sounding Reference Signal (SRS) information for at least one cell from the set of interfering cells.

10. The method of claim 1, wherein the detecting further comprises:
monitoring the one or more received signals for a threshold time or frequency period;
estimating one or more signal features based on filtering the monitored one or more received signals; and
determining the system release version information based on the one or more estimated signal features.

11. The method of claim 10, wherein the one or more signal features include at least one of: UE-RS usage, transmission mode, CSI-RS presence or absence, carrier type, ePDCCH presence or absence, ABS configuration, aperiodic SRS configuration, or RB bundling.

12. The method of claim 1, further comprising:
communicating the detected system release version information to at least one network entity, wherein the at least one network entity comprises at least one of: a UE, or an eNB.

13. The method of claim 1, wherein the receiving further comprises receiving system release version information from one or more network entities, and wherein the modifying further comprises:
modifying the communication processing based on the received system release version information.

14. The method of claim 13, wherein the one or more network entities include at least one of: a UE, or an eNB.

15. The method of claim 13, wherein the one or more network entities comprise two or more UEs, wherein the method further comprises determining an improved release version information based on the system release version information received from the two or more UEs, and wherein the modifying the communication process further comprises at least one of:
broadcasting the improved release version information; or
transmitting the improved release version information to the two or more UEs.

16. The method of claim 1, wherein the modifying further comprises:
modifying physical downlink channel processing based on the detected system release version information.

17. The method of claim 1, wherein the modifying further comprises:
modifying interference cancelation (IC) operations based on the detected system release version information.

18. The method of claim 17, wherein the IC operations include at least one of: CRS-IC, primary synchronization signal (PSS)-IC, physical broadcast channel (PBCH)-IC, Physical Hybrid-ARQ Indicator Channel (PHICH)-IC, Physical Downlink Control Channel (PDCCH)-IC, or Physical Downlink Shared Channel (PDSCH)-IC.

19. An apparatus for wireless communication, comprising:
means for receiving, by a user equipment (UE), one or more signals from each cell of a plurality of cells including a set of interfering cells, the set of interfering cells including one or more interfering cells;
means for detecting system release version information for at least one cell from the set of interfering cells; and
means for modifying communication processing with a serving cell based on the detected system release version information for the at least one cell from the set of interfering cells.

20. A computer program product, comprising:
a computer-readable medium comprising code for:
receiving, by a user equipment (UE), one or more signals from each cell of a plurality of cells including a set of interfering cells, the set of interfering cells including one or more interfering cells;
detecting system release version information for at least one cell from the set of interfering cells; and
modifying communication processing with a serving cell based on the detected system release version information for the at least one cell from the set of interfering cells.

21. A apparatus for wireless communication, comprising:
a processing system configured to:
receive, by a user equipment (UE), one or more signals from each cell of a plurality of cells including a set of interfering cells, the set of interfering cells including one or more interfering cells;
detect system release version information for at least one cell from the set of interfering cells; and
modify communication processing with a serving cell based on the detected system release version information for the at least one cell from the set of interfering cells.

22. The apparatus of claim 21, wherein at least one of one of the one or more signals includes a system information block (SIB) configured with a first structure, and wherein the processing system is further configure to detect the system release version information based on the first structure of the SIB.

23. The apparatus of claim 21, wherein one cell of the plurality of cells is a serving cell, and wherein the one or more received signals include at least one of:
system release version information for the serving cell;
system release version information for at least one cell from the set of interfering cells; or
information associated with features, from which the system release version information can be inferred, for at least one of plurality of cells.

24. The apparatus of claim 21, wherein at least one signal of one of the one or more signals includes a channel state information reference signal (CSI-RS) tone, and wherein the processing system is further configure to detect the system release version is a long term evolution (LTE) release 10 or newer version.

25. The apparatus of claim 24, wherein the processing system is further configure to:
detect that an energy level associated with the CSI-RS tone is below a physical cell identifier (PCI) energy threshold value; and
determine that the system release version is a LTE release 11 or newer version.

26. The apparatus of claim 21, wherein the processing system is further configure to:
determine that at least one signal of the one or more received signals includes an evolved physical downlink control channel (ePDCCH); and
determine that the system release version is a LTE release 11 or newer version based on the presence of the ePDCCH.

27. The apparatus of claim 21, wherein the processing system is further configure to:
determine that none the one or more received signals include an Physical Control Format Indicator Channel (PCFICH); and
determine that the system release version corresponds to a legacy carrier.

28. The apparatus of claim 21, wherein the processing system is further configure to:
detect a number of common reference signals (CRS) are present during a duration of time; and
determine that the system release version corresponds to a legacy carrier based on the detected number of CRS during the duration of time.

29. The apparatus of claim 21, wherein the processing system is further configure to detect at least one of:
a transmission mode for at least one cell from the set of interfering cells;
almost blank subframe (ABS) configuration for at least one cell from the set of interfering cells;
carrier type information for at least one cell from the set of interfering cells;
carrier aggregation information for at least one cell from the set of interfering cells; or
aperiodic Sounding Reference Signal (SRS) information for at least one cell from the set of interfering cells.

30. The apparatus of claim 21, wherein the processing system is further configure to:
monitor the one or more received signals for a threshold time or frequency period;
estimate one or more signal features based on filtering the monitored one or more received signals; and
determine the system release version information based on the one or more estimated signal features.

31. The apparatus of claim 30, wherein the one or more signal features include at least one of: UE-RS usage, transmission mode, CSI-RS presence or absence, carrier type, ePDCCH presence or absence, ABS configuration, aperiodic SRS configuration, or RB bundling.

32. The apparatus of claim 21, wherein the processing system is further configure to:
communicate the detected system release version information to at least one network entity, wherein the at least one network entity comprises at least one of: a UE, or an eNB.

33. The apparatus of claim 21, wherein the processing system is further configure to:
receive system release version information from one or more network entities; and
modify the communication processing based on the received system release version information.

34. The apparatus of claim 33, wherein the one or more network entities include at least one of: a UE, or an eNB.

35. The apparatus of claim 33, wherein the one or more network entities comprise two or more UEs, and wherein the processing system is further configure to:
determine an improved release version information based on the system release version information received from the two or more UEs, and wherein the processing system is further configure to perform at least one of:
broadcasting the improved release version information; or
transmitting the improved release version information to the two or more UEs.

36. The apparatus of claim 21, wherein the processing system is further configure to:
modify physical downlink channel processing based on the detected system release version information.

37. The apparatus of claim 21, wherein the processing system is further configure to:
modify interference cancelation (IC) operations based on the detected system release version information.

38. The apparatus of claim 37, wherein the IC operations include at least one of: CRS-IC, primary synchronization signal (PSS)-IC, physical broadcast channel (PBCH)-IC, Physical Hybrid-ARQ Indicator Channel (PHICH)-IC, Physical Downlink Control Channel (PDCCH)-IC, or Physical Downlink Shared Channel (PDSCH)-IC.
